(19) United States
(12) Patent Application Publication
(10) Pub. No.: US 2003/0041026 A1
(43) Pub. Date: Feb. 27, 2003

(54) Method and system for transmission of messages

(76) Inventors: Petteri Heinonen, Espoo (FI); Sami Oinonen, Helsinki (FI)

Correspondence Address: COHEN, PONTANI, LIEBERMAN & PAVANE, Suite 1210, 551 Fifth Avenue, New York, NY, 10176, US

(21) Appl. No.: 09/923,255

(22) Filed: Aug. 2, 2001

(30) Foreign Application Priority Data
Feb. 9, 1999 (FI) 990254
Feb. 2, 2000 PCT/FI00/00072

(51) Int. Cl. G06F 17/60

(52) U.S. Cl. 705/41

(57) ABSTRACT

A method and system for the transmission of payment messages in a telecommunication system that includes a smart card, a payment application on the smart card, a telecommunication connection and a payment server disposed in a telecommunication network and connected to the payment application. In the inventive method, a smart card client is disposed on the smart card, the payment application is connected to the smart card client, a smart card server is provided in the telecommunication network and is connected to the payment server, and the smart card client is connected to the smart card server via the telecommunication connection. The inventive system includes a smart card client disposed on the smart card and connected to the payment application, and a smart card server disposed in the telecommunication network and connected both to the payment server and, via the telecommunication connection, to the smart card client. The invention optimizes the exchange of messages between the payment application and the payment server in a manner appropriate for a mobile communication system.

### BACKGROUND OF THE INVENTION

1. Field of the Invention

The present invention relates to telecommunication systems and, more particularly, to the transmission of payment messages between a client application and a payment server in a telecommunication system.

2. Description of Related Art

Payment systems in which, for example, a mobile station in a telecommunication system can be used to remit payments are known in the art. Most existing payment applications have basically been designed for an environment in which the number of payment messages to be exchanged is insufficient to significantly hamper operation of the application. This means that the transmission path is a linear and short connection, as for example that between a smart card and a card reader, so that neither the number of messages nor the speed of transmission presents a problem or impediment to its use. Thus, from the user's point of view the transactions are executed at a sufficient or acceptable speed.

By way of illustration, an existing electronic purse called SetPurse, which is implemented on the subscriber identity module (SIM) of a mobile station, uses a method of exchange of information that generally corresponds to that employed when a purse is used with a fixed smart card reader. In a mobile station application, the payment messages must cross (i.e. be transmitted across) a wireless communication or connection interface, which adds a significant measure of insecurity in the transmission path. Moreover the response time experienced in the conduct of such payment transactions, particularly when short messages are used to implement the transmissions, may become annoyingly long for the user.

In addition, a payment system implemented on a smart card may be dependent on the supplier of the smart card, which presents a problem for the mobile telephone operator because the payment system provided by the operator is then dependent on another or third party.

### OBJECTS AND SUMMARY OF THE INVENTION

It is accordingly the desideratum of the present invention to eliminate, or at least significantly reduce or alleviate, the problems inherent in prior art systems and methods as for example as hereinabove described.

It is a particular object of the invention to provide a novel and unobvious method and system for optimizing the exchange of messages between a payment application and a payment server in a telecommunication system.

The invention is broadly directed, inter alia, to a method for the transmission of payment messages in a telecommunication system that includes a smart card, a payment application disposed on the smart card, a telecommunication connection and a payment server located in (or associated with) a telecommunication network and connected to the payment application via the telecommunication connection. In the inventive method, a smart card client is located or stored on the smart card and is connected to the payment application. The telecommunication network is provided with a smart card server to which the payment server is connected, and the smart card client is connected to the smart card server via the telecommunication connection. The smart card may, for example, be a SIM card that is connected to a mobile station and the telecommunication connection may be implemented as a wireless connection established via a GSM (Global System for Mobile communication) system or other network.

In a preferred embodiment of the invention, a new type of interface formed between the payment application and the payment server is used to optimize the number of messages crossing the radio interface. The optimization may be performed by the smart card client, with a payment message intended to be transmitted from the payment application to the payment server being stored on the smart card client and a message composed of one or more messages then being sent to the smart card server. In a preferred implementation, a suitable response message—which may be produced in the form or format of a message sent by the payment server—is sent from the smart card client to the payment application. The response message may be generated on the basis of a message received by the smart card client from the smart card server.

Corresponding optimization can also be performed by or implemented with the smart card server. Preferably, both the smart card client and the smart card server participate in the optimization, in which case a new type of interface is formed between the payment application and the payment server—an interface which, in a preferred embodiment, crosses a wireless connection. In accordance with and using this new interface, a message to be transmitted from the payment server to the payment application is stored on the smart card server and a message composed of one or more messages is then sent across the telecommunication connection to the smart card client. A response message may be sent by the smart card server to the payment server, and the response message may be generated in the form or format of a message sent by the payment application. A response message may also be generated based on a message received by the smart card server from the smart card client.

The serviceability or operability of the connections both between the payment server and payment application and between the smart card server and smart card client may be assured or confirmed by initiating the transmission of payment messages as a communication between the payment server and payment application. Transmission of subsequent payment messages is then continued by transmitting the message via the smart card client and smart card server.

Communication through telecommunication connection contemplated for use in connection with the present invention may be implemented by selecting from among a multiplicity of different alternatives, such for example as a function of that alternative which is deemed to be most appropriate for the particular situation. One or more telecommunication connection implementations may be utilized in the practice of the invention, such as a telecommunication connection based on short messages or on the USSD (Unstructured Supplementary Service Data), WAP (Wireless Application Protocol) or GPRS (General Packet Radio Service) protocols.

The invention also provides a system for the transmission of payment messages in a telecommunication system as described above. The system of the invention comprises a smart card client disposed on a smart card and connected to a payment application, a smart card server disposed in a telecommunication network and connected to a payment server, and a telecommunication connection connecting the smart card client to the smart card server.

A preferred embodiment of the inventive system further comprises means for optimizing the exchange of payment messages between the payment server and the payment application. This optimization reduces the number of messages that are or need be transmitted over the telecommunication connection, thereby realizing an advantageous savings in available radio interface capacity and enhancing security.

In various embodiments or implementations of the inventive system, the smart card client may comprise means for storing a message to be transmitted from the payment application to the payment server and means for sending a message composed of one or more messages to the smart card server. The smart card client preferably also comprises means for sending a response message to the payment application. The smart card client may comprise means for generating a response message in the form or format of a message sent by the payment server, and may comprise means for generating a response message on the basis of a message received from the smart card server.

The smart card server may comprise means for storing a message to be transmitted from the payment server to the payment application and means for sending a message composed of one or more messages to the smart card client. The smart card server preferably also comprises means for sending a response message to the payment server. The smart card server may comprise means for generating a response message in the form of a message sent by the payment application.

The inventive system may further comprise means for starting or initiating the transmission of payment messages as a communication between the payment server and the payment application, and means for thereafter continuing the transmission of payment messages such that the messages are transmitted via the smart card client and the smart card server, thus assuring that the connection is serviceable or operable.

The smart card server may also comprise means for generating a response message on the basis of a message received from the smart card client. Currently contemplated modes of transmission via the telecommunication connection in the system of the invention may by way of example include one or more of short messaging, the USSD protocol, the WAP protocol or the GPRS protocol.

The present invention advantageously reduces the exchange of messages in a payment situation, thereby providing considerable savings in communications and system capacity, particularly with respect to crossing of the radio interface. The invention also reduces response times during payment-instructing and effecting activities. The use of a separate interface makes it possible to insure that the payment databases are not visible to outsiders, thus improving data security. In addition, from the operator's point of view the invention reduces its dependency on third party smart card suppliers who may have their own manufacturer-supplier protocol for the exchange of payment messages. The invention also makes it possible to establish interfaces to many different payment systems, thus increasing the number of alternatives available to the subscribers or users. Furthermore, the security of the payment transaction is improved since fewer messages are transmitted over a nonsecure radio interface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference numerals denote similar elements throughout the several Figures:

FIG. 1 is a diagrammatic representation of a system in accordance with the present invention; and

FIG. 2 is a diagrammatic depiction of a signaling scheme in accordance with the invention.

### DETAILED DESCRIPTION OF THE CURRENTLY PREFERRED EMBODIMENTS

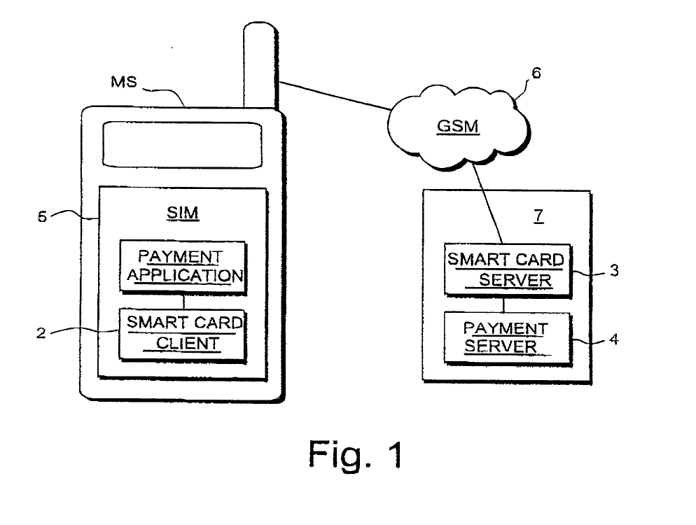

Shown in FIG. 1 of the drawings are the relevant components of a system constructed in accordance with the invention and presented in diagrammatic form. A payment application 1 and a smart card client 2 are disposed or stored or carried on a smart card 5, which may for example be a subscriber identity module (SIM) card such as is commonly used in mobile communication systems. The smart card 5 is typically connected to a telecommunication terminal MS, such as a mobile station consistent with and operable as a part of or adjunct to a GSM system. The terminal MS is connected via a telecommunication connection 6 to a smart card server 3. The telecommunication connection 6 may for example be a digital mobile telephone link or connection based on the GSM system and may be implemented using, by way of nonlimiting illustration, short messages, messages consistent with the USSD or WAP protocol, or combinations thereof. Various additional well known components that form a typical telecommunication system or that are utilized in establishing the telecommunication connection 6 but which are neither specific to nor form a direct part of the present invention are omitted from FIG. 1, and from this description, to simplify and facilitate this disclosure and an understanding and appreciation of the invention.

The smart card server 3 and payment server 4 are disposed in or otherwise associated with a telecommunication network 7. The term “telecommunication network”, as used herein, is intended to refer to a combination of transmission paths and nodes that form connections between two or more points for telecommunication between those points. The telecommunication network may for example be a body consisting of a single component or a fully or partly distributed system with the smart card server 3 and payment server 4 disposed in physically separate components. In any event, the smart card server 3 is so connected to the payment server 4 that payment messages from the payment application 1 to the payment server 4 are transmitted one to the other via the smart card server 3 and smart card client 2.

Nevertheless, in at least one embodiment of the invention the initial connection or communication may instead be established without the smart card client 2 and smart card server 3—i.e. directly between the payment application and payment server.

In the form of the inventive system shown by way of example in FIG. 1, the smart card client 2 is implemented as software located or stored on the SIM card, so that the means comprised in the smart card client are also implemented as software. The term “storing means” refers herein to a property of the smart card client 2 that permits and implements operative storage of information on the SIM card. Using sending or transmission means, the smart card client 2 transfers information either to the payment application 1 or to the telecommunication terminal MS; in the latter case the terminal MS implements further transmission of the information to smart card server 3.

Smart card server 3 and the means comprised therein may likewise be implemented as software in a network component managed by the network operator. The payment server 4 can be implemented in the same network component or, alternatively, in a separate component in which case a separate telecommunication connection is established between the payment server 4 and smart card server 3.

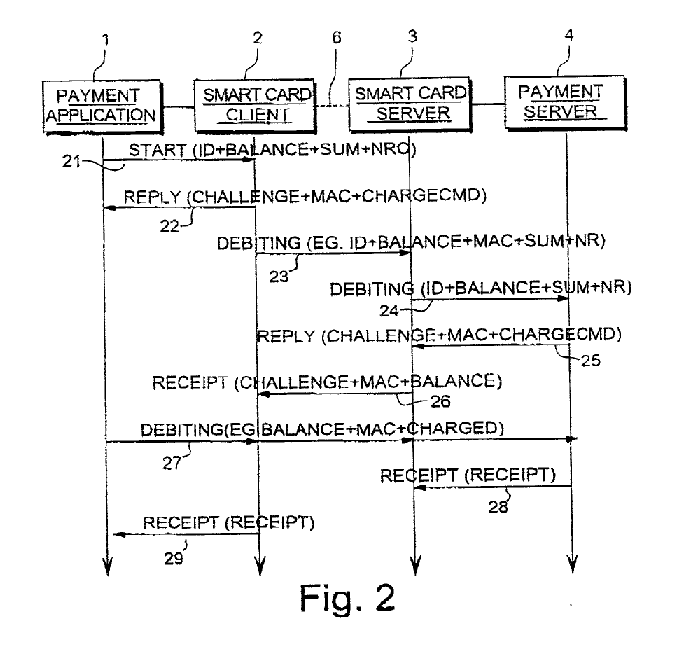

FIG. 2 presents by way of illustrative example a signaling scheme implemented in accordance with the present invention for a payment transaction using the known SetPurse-type smart card purse. In this particular instance both the payment application 1 and the payment server 4 correspond to heretofore known components of the SetPurse payment application.

The payment application 1 sends to the smart card client 2, as in the prior art, a START message (represented in FIG. 2 by the arrow 21) that is intended for the payment server 4. The message comprises the following information elements: ID, which is a code that identifies the payment application; BALANCE, which reports the money available in or for use by the payment application; SUM, which indicates the amount to be used in this transaction; and NRO, which denotes the identification number of the transaction. The smart card client 2 stores the message 21 and sends to the payment application 1 an acknowledgement message REPLY 22 which comprises the information elements CHALLENGE (a debiting command), MAC (a message authentication code), and CHARGECMD (a message identifier). Message 22 corresponds to a response message that is sent by the payment server 4 in the prior art. Thus, in accordance with the invention, the smart card client 2 generates the response message without the radio interface of the telecommunication connection 6 being crossed.

Smart card client 2 generates from messages 21 and 22 a DEBITING message 23 that is to be sent to the smart card server 3. Message 23 comprises the ID, BALANCE, SUM and NRO elements from message 21, and the MAC element from message 22. The smart card server 3 stores the message 23 and sends a DEBITING message 24 (that corresponds to message 21) to payment server 4. Payment server 4 answers the message, as in the prior art, with a REPLY message 25 that resembles message 22. In message 25 the CHALLENGE, MAC and CHARGECMD information elements may differ from those included in message 22, in which case the smart card server 3 and smart card client 2 perform a conversion of the corresponding identifiers. Smart card server 3 then sends to smart card client 2 an acknowledgement message RECEIPT 26, which comprises the information elements CHALLENGE and MAC from message 25 and the information element BALANCE.

Payment application 1 sends to smart card client 2 a message DEBITING 27 which comprises the information elements BALANCE, MAC and CHARGED, i.e. the amount payable by the payment application. After corresponding conversions, the message 27 is further transmitted from smart card client 2 to payment server 4, which responds by sending an acknowledgement message RECEIPT 28 to smart card server 3. The smart card client 2 similarly sends an acknowledgement message RECEIPT 29 to payment application 1. The operation of the acknowledgement messages 28 and 29 may be secured by, for example, having the smart card client 2 wait for a predetermined length of time before sending the acknowledgement message 29. If smart card server 3 does not receive an acknowledgement message 28 of the correct type from the payment server, then it sends an error message to smart card client 2.

To insure that the connection between different components is serviceable or operational, a connection may initially be established between the payment application 1 and payment server 4, without smart card client 2 and smart card server 3, at the beginning of the payment transaction. This feature may for example be utilized in failure diagnosis and the like.

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. In a method for transmission of payment messages in a system that includes a smart card, a payment application on the smart card, a telecommunication network, a smart card server in the telecommunication network, and a payment server in the telecommunication network and connected to the payment application via a telecommunication connection, and wherein a smart card client is disposed on the smart card and connected to the payment application, the payment server is connected to the smart card server, and the smart card client is connected to the smart card server via the telecommunication connection, the improvement comprising:
optimizing exchange of payment messages between the payment application and the payment server over an interface defined at least in part by the telecommunication connection between the smart card client and the smart card server by
storing in the smart card client a message, from the payment application, to be transmitted from the payment application to the payment server,
sending to the smart card server a first composite message comprised of at least one message intended for transmission over the telecommunication connection,
storing on the smart card server a message to be transmitted over the telecommunication connection from the payment server to the payment application, and
sending to the smart card client a second composite message comprised of at least one message intended for transmission over the telecommunication connection.

2. In a method in accordance with claim 1, further comprising the step of sending a response message from the smart card client to the payment application.

3. In a method in accordance with claim 2, wherein the response message is formed as a message from the payment server.

4. In a method in accordance with claim 2, wherein the response message is based on a message received by the smart card client from the smart card server over the telecommunication connection.

5. In a method in accordance with claim 1, further comprising the step of sending a response message from the smart card server to the payment server.

6. In a method in accordance with claim 5, wherein the response message is formed as a message sent by the payment application.

7. In a method in accordance with claim 5, wherein the response message is based on a message received by the smart card server from the smart card client over the telecommunication connection.

8. In a method in accordance with claim 1, further comprising the step of insuring operability of communication between the payment application and the payment server, by
initiating a payment application transaction with an intiating transmission of a payment message between the payment server and the payment application, and
after said initiating transmission, continuing transmission of payment messages via the smart card client and the smart card server.

9. In a method in accordance with claim 1, wherein communication via the telecommunication connection is implemented using short messages.

10. In a method in accordance with claim 1, wherein communication via the telecommunication connection is implemented using USSD protocol.

11. In a method in accordance with claim 1, wherein communication via the telecommunication connection is implemented using WAP protocol.

12. In a method in accordance with claim 1, wherein communication via the telecommunication connection is implemented using GPRS protocol.

13. In a system for transmission of payment messages that includes a smart card, a payment application on the smart card, a telecommunication network, a smart card server in the telecommunication network, and a payment server in the telecommunication network and connected to the payment application via a telecommunication connection, and wherein a smart card client is disposed on the smart card and connected to the payment application, the payment server is connected to the smart card server, and the smart card client is connected to the smart card server via the telecommunication connection, the improvement comprising:
means for optimizing exchange of payment messages between the payment application and the payment server over an interface defined at least in part by the telecommunication connection between the smart card client and the smart card server, said optimizing means comprising:
means for storing a message to be transmitted from the payment application to the payment server,
means for sending to the smart card server a first composite message comprised of at least one message,
means for storing a message to be transmitted over the telecommunication connection from the payment server to the payment application, and
means for sending to the smart card client a second composite message comprised of at least one message.

14. In a system in accordance with claim 13, wherein the smart card client comprises means for sending a response message to the payment application.

15. In a system in accordance with claim 14, wherein the smart card client comprises means for forming the response message as a message from the payment server.

16. In a system in accordance with claim 14, wherein the smart card client further comprises means for basing the response message on a message received by the smart card client from the smart card server over the telecommunication connection.

17. In a system in accordance with claim 14, wherein the smart card server comprises means for sending a response message to the payment server.

18. In a system in accordance with claim 17, wherein the smart card server comprises means for forming the response message as a message from the payment application.

19. In a system in accordance with claim 17, wherein the smart card server comprises means for basing the response message on a message received from the smart card client.

20. In a system in accordance with claim 13, further comprising:
means for initiating a payment application transaction with an initiating transmission of a payment message between the payment server and the payment application to insure operability of communication between the payment application and the payment server; and
means for continuing, after said initiating transmission, transmission of payment messages via the smart card client and the smart card server.

21. In a system in accordance with claim 13, wherein communication via the telecommunication connection is implemented using short messages.

22. In a method in accordance with claim 13, wherein communication via the telecommunication connection is implemented using USSD protocol.

23. In a method in accordance with claim 13, wherein communication via the telecommunication connection is implemented using WAP protocol.

24. In a method in accordance with claim 13, wherein communication via the telecommunication connection is implemented using GPRS protocol.
